(19) United States
(12) Patent Application Publication
(10) Pub. No.: US 2025/0335148 A1
(43) Pub. Date: Oct. 30, 2025

(54) AUDIO PLAYBACK SYSTEM

(71) Applicant: Primax Electronics Ltd., Taipei City (TW)

(72) Inventors: Chun-Nan SU, Taipei City (TW); Shih-Chieh HSU, Taipei City (TW); Yu-An LO, Taipei City (TW); Pao-Chung CHAO, Taipei City (TW); Tzu-Chi TSENG, Taipei City (TW)

(21) Appl. No.: 18/676,532

(22) Filed: May 29, 2024

(30) Foreign Application Priority Data
Apr. 30, 2024 (TW) 113116232

(51) Int. Cl. G06F 3/16; H04R 5/033

(52) U.S. Cl. CPC G06F 3/162; G06F 3/165; H04R 5/033; H04R 2420/07

(57) ABSTRACT

An audio playback system includes an audio output device and a computing device. The computing device executes an application program. A sound signal corresponding to the application program and an EQ setting are transmitted from the computing device to the audio output device. After the sound signal and the EQ setting from the computing device are received by the audio output device, the audio output device outputs sound according to the EQ setting.

### FIELD OF THE INVENTION

The present invention relates to an audio playback system, and more particularly to an audio playback system capable of automatically adjust EQ settings.

### BACKGROUND OF THE INVENTION

Generally, the conventional audio playback system comprises a computing device and an audio playback device. When an application program in the computing device is executed, the audio playback device cannot automatically and immediately output sound with an EQ setting suitable for the application program. Instead, the user has to manually adjust the EQ setting through a button, a switch or a touch module on the audio playback device. In other words, the conventional audio playback system is inconvenient to the user.

### SUMMARY OF THE INVENTION

In order to overcome the drawbacks of the conventional technologies, the present invention provides an intelligent audio playback system. When a computing device of the audio playback system executes an application program, an audio playback device of the audio playback system will automatically output sound with the EQ setting specific to the application program. Consequently, the problem of manually and passively adjusting the EQ setting by the user will be solved.

In accordance with an aspect of the present invention, an audio playback system is provided. The audio playback system includes an audio output device and a computing device. The computing device executes an application program. A sound signal corresponding to the application program and an EQ setting are transmitted from the computing device to the audio output device. After the sound signal and the EQ setting from the computing device are received by the audio output device, the audio output device outputs sound according to the EQ setting.

In an embodiment, the EQ setting is a combination of plural sound bands and gain values corresponding to the plural sound bands.

In an embodiment, when the computing device executes an EQ setting program, the application program being executed by the computing device is detected or compared, and the EQ setting corresponding to this application program is transmitted to the audio output device, so that the audio output device outputs the sound according to the EQ setting.

In an embodiment, if the EQ setting program does not detect the application program that is being executed by the computing device, the audio output device outputs the sound according to a default EQ setting.

In an embodiment, the EQ setting program is a driver, a utility program, a background program or a resident program.

In an embodiment, the audio output device is a headphone, a speaker, a smart speaker or a conference speaker, and the computing device is a desktop computer, a notebook computer, an integrated full-function computer, a minicomputer, a computer stick, a tablet computer, a mobile phone, a broadcaster or a live broadcast controller.

In an embodiment, the audio output device is in communication with the computing device in a wired transmission manner or a wireless transmission manner.

In an embodiment, when the audio output device and the computing device are in communication with each other in a wired transmission manner, the computing device automatically execute the EQ setting program, or the computing device disables the EQ setting program.

In an embodiment, when the audio output device is paired with the computing device in a Bluetooth communication manner, the computing device automatically execute the EQ setting program, or the computing device disables the EQ setting program.

In an embodiment, when the audio output device is paired with the computing device through a dongle, the computing device automatically execute the EQ setting program, or the computing device disables the EQ setting program.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates an audio playback system according to a first embodiment of the present invention;

FIG. 2 is an implementation example of the EQ setting in the audio playback system of the present invention;

FIG. 3 schematically illustrates an audio playback system according to a second embodiment of the present invention; and

FIG. 4 schematically illustrates an audio playback system according to a third embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

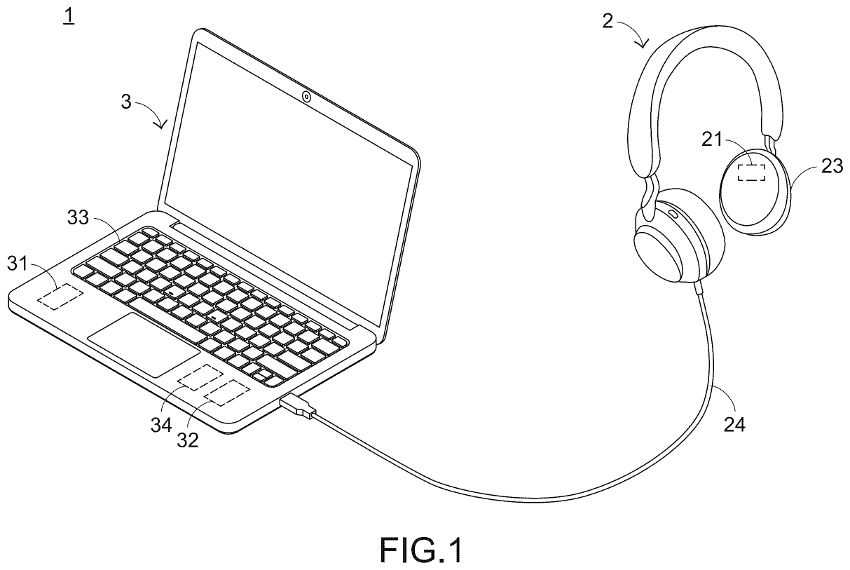

FIG. 1 schematically illustrates an audio playback system according to a first embodiment of the present invention. As shown in FIG. 1, the audio playback system 1 comprises an audio output device 2 and a computing device 3. The audio output device 2 is a headphone, a speaker, a smart speaker, a conference speaker or any other appropriate device capable of outputting audio signals. For example, the computing device 3 is a desktop computer, a notebook computer, an integrated full-function computer, a minicomputer, a computer stick, a tablet computer, a mobile phone, a broadcaster, a live broadcast controller, or any other appropriate device. In this embodiment, the audio output device 2 is a headphone, and the computing device 3 is a notebook computer.

The computing device 3 comprise a processor 31. Preferably but not exclusively, the processor 31 is an X86 architecture processor or an ARM architecture processor. The computing device 3 further comprises a communication unit 32 and a human interface device (HID) 33 to facilitate signal transmission and communication with the audio output device 2 and to accept user operations or instructions. Furthermore, the audio output device 2 comprises a control unit 21, a communication unit 22 and a speaker unit 23 to facilitate receiving the audio signals from the computing device 3 and then smoothly playing the audio signals.

In the audio playback system 1 of this embodiment, the computing device 3 is used to execute an application program. In addition, a sound signal corresponding to the application program and an EQ setting are transmitted to the audio output device 2. After the sound signal and the EQ setting from the computing device 3 are received by the audio output device 2, the audio output device 2 will output sound according to the EQ setting. Since the operation of the audio output device 2 matches the application program being executed by the computing device 3 in time, the problem of frequently and manually adjusting the setting by the user can be solved. Especially, when a first application program is switched to a second application program by the user, the EQ setting corresponding to the second application program will be instantly transmitted from the computing device 3 to the audio output device 2. Consequently, the automatic and intelligent switching function can be achieved.

Generally, different frequency levels of sound will give people different auditory feelings. For example, the high-frequency sound feels bright to people, and the low-frequency sound feels rich and full to people. In addition, EQ is the abbreviation of Equalizer in English. The equalizer is a device or software used to adjust the gain value of the sound in a specified frequency range (or frequency band), so that the sound in the specified frequency band can be amplified or attenuated. The EQ setting refers to the combination of plural sound bands and their corresponding gain values. In this embodiment, the number of sound bands is plural. For example, the plural sound bands can be classified into two frequency bands (e.g., a treble band and a bass band), three frequency bands (e.g., a treble band, a midrange band and a bass band), four frequency bands (e.g., a high band, a mid-high band, a mid-low band and a low band), six frequency bands, ten frequency bands, twenty frequency bands, thirty frequency bands, or any other common frequency bands. The range of the gain values in not restricted. For example, the common range of the gain values, e.g., ±12 db range or ±15 db range, is feasible.

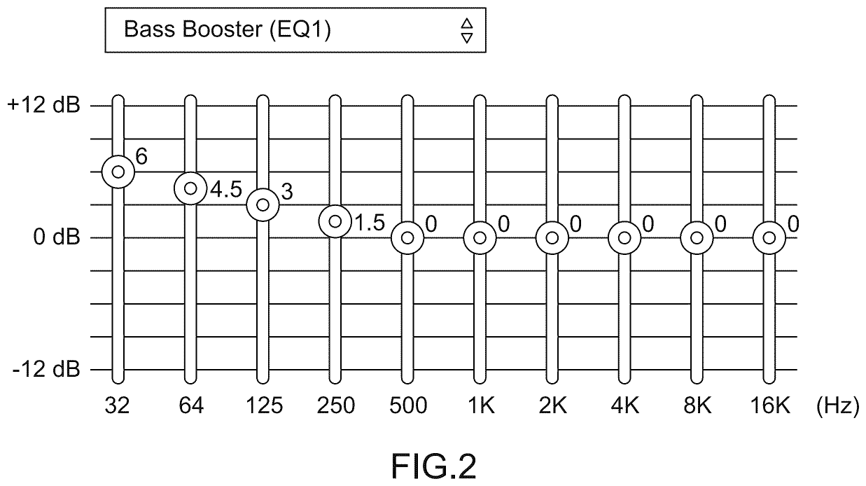

FIG. 2 is an implementation example of the EQ setting in the audio playback system of the present invention. For example, in the EQ setting, the sound bands are classified into ten frequency bands. The center frequency points of the frequency bands are respectively 32 Hz, 64 Hz, 125 Hz, 250 Hz, 500 Hz, 1 KHz, 2 KHz, 4 KHz, 8 KHz and 16 KHz. The gain values of the center frequency points of the ten frequency bands are set to 6 dB, 4.5 dB, 3 dB, 1.5 dB, 0 dB, 0 dB, 0 dB, 0 dB, 0 dB, and 0 dB respectively. The above EQ setting belongs to a sound scenario in a bass boost mode. Its name can be described, distinguished and stored with a word (e.g., bass booster), a code name (e.g., EQ1) or a code (e.g., 001). Similarly, different application programs also have different names, code names or codes.

The operating interface for the above EQ setting is presented in the form of graphical settings such as sliders or knobs. However, in some other embodiments, the operating interface can also be presented in the form of parameter setting or table input, which is convenient for the use to make settings. Furthermore, the EQ setting will be further converted into a data format that can be read or communicated by the computing device 3 and the audio output device 2. For example, in a data format, the data, the code names, the codes or the numbers that completely record the gain values of all frequency bands are suitable. As long as the audio output device 2 can recognize or understand the meaning of the above-mentioned code names, codes or numbers and the content of the corresponding EQ setting, the data format is not restricted.

In the audio playback system 1 of this embodiment, the application program executed by the computing device 3 is a foreground application program or a background application program. For example, the application program is a game program, a video player program, a conference program, or the like. When the above-mentioned application program is executed by the computing device 3, the computing device 3 loads or plays the sound signal corresponding to the application program. For example, when a video game program is executed by the computing device 3, the loads or plays the background music, the game sound effect, the character voice or any other appropriate sound signal corresponding to the video game program. When the user operates or participates in a different video game, the sound output with the different EQ setting will give the completely different feeling to the user.

In the audio playback system 1 of this embodiment, the computing device 3 can execute an EQ setting program. When the EQ setting program is executed, the application program being executed by the computing device 3 is detected or compared, and the EQ setting corresponding to this application program is transmitted to the audio output device 2. According to the EQ setting, the audio output device 2 outputs sound. For example, the EQ setting program is a driver, a utility program, a background program or a resident program.

The operating interface for the EQ setting program is presented in the form of graphical setting, parameter setting or table input. The user can click or enter the names of various application programs through this operating interface, and then set the gain values specific to the application programs in various sound bands. The names of various application programs and the gain values specific to the application programs are stored in a memory 34 of the computing device 3 so as to be read or compared by the EQ setting program. Furthermore, the EQ setting program can also have or load a variety of default EQ settings, e.g., Pop, Rock, Classical, Jazz, Vocal, Electric or live EQ settings. The default EQ settings can be selected as options through texts, codes or code names and stored in the memory 34 of the computing device 3.

In the audio playback system 1 of this embodiment, the audio output device 2 can be in communication with the computing device 3 in a wired transmission manner or a wireless transmission manner. For example, the audio output device 2 shown in FIG. 1 is connected with the computing device 3 through a connecting cable 24. Consequently, signals are transmitted and communicated between the audio output device 2 and the computing device 3 in the wired transmission manner.

It is noted that numerous modifications and alterations may be made while retaining the teachings of the invention.

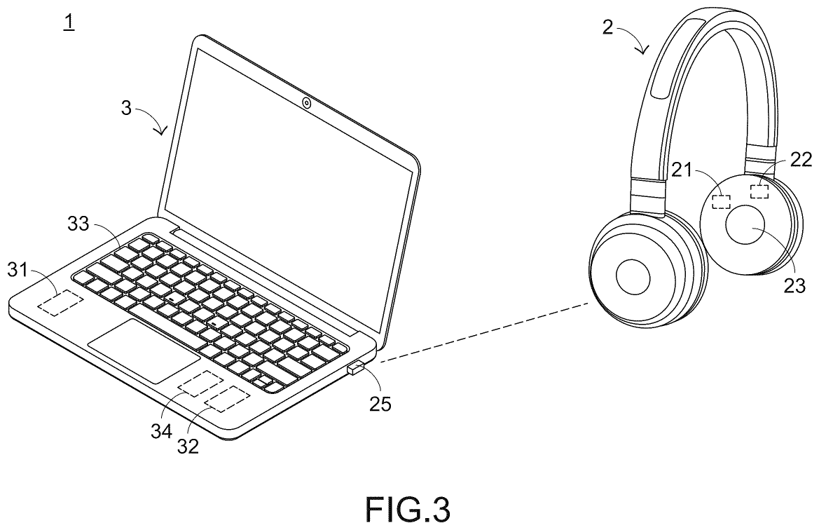

FIG. 3 schematically illustrates an audio playback system according to a second embodiment of the present invention. In the audio playback system 1 shown in FIG. 3, the audio output device 2 is connected with the computing device 3 through a dongle 25. Consequently, signals are transmitted and communicated between the audio output device 2 and the computing device 3 in the wireless transmission manner.

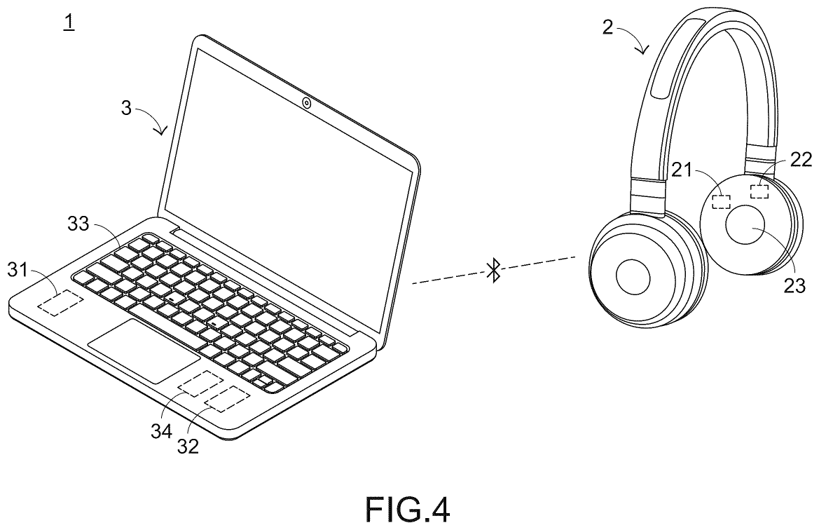

FIG. 4 schematically illustrates an audio playback system according to a third embodiment of the present invention. In the audio playback system 1 shown in FIG. 4, the audio output device 2 is connected with the computing device 3 in a Bluetooth communication manner. That is, signals are transmitted and communicated between the audio output device 2 and the computing device 3 in the wireless transmission manner.

In case that the audio output device 2 and the computing device 3 are in communication with each other in the wired transmission manner, the computing device 3 can automatically execute the EQ setting program, or the computing device 3 can disable the execution of the EQ setting program through preset settings until the user activates the EQ setting program. Similarly, in case that the audio output device 2 is paired with the computing device 3 through the dongle 25, the computing device 3 can automatically execute the EQ setting program, or the computing device 3 can disable the execution of the EQ setting program. Similarly, in case that the audio output device 2 is paired with the computing device 3 in the Bluetooth communication manner, the computing device 3 can automatically execute the EQ setting program, or the computing device 3 can disable the execution of the EQ setting program.

Moreover, if the EQ setting program does not detect the foreground application program that is being executed by the computing device, or if the audio output device does not receive the EQ setting from the computing device, the audio output device will output the sound according to a default EQ setting. The default EQ setting can be previously set in advance through the EQ setting program.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. An audio playback system, comprising:
an audio output device; and
a computing device executing an application program, wherein a sound signal corresponding to the application program and an EQ setting are transmitted from the computing device to the audio output device,
wherein after the sound signal and the EQ setting from the computing device are received by the audio output device, the audio output device outputs sound according to the EQ setting.

2. The audio playback system according to claim 1, wherein the EQ setting is a combination of plural sound bands and gain values corresponding to the plural sound bands.

3. The audio playback system according to claim 2, wherein when the computing device executes an EQ setting program, the application program being executed by the computing device is detected or compared, and the EQ setting corresponding to this application program is transmitted to the audio output device, so that the audio output device outputs the sound according to the EQ setting.

4. The audio playback system according to claim 3, wherein if the EQ setting program does not detect the application program that is being executed by the computing device, the audio output device outputs the sound according to a default EQ setting.

5. The audio playback system according to claim 3, wherein the EQ setting program is a driver, a utility program, a background program or a resident program.

6. The audio playback system according to claim 1, wherein the audio output device is a headphone, a speaker, a smart speaker or a conference speaker, and the computing device is a desktop computer, a notebook computer, an integrated full-function computer, a minicomputer, a computer stick, a tablet computer, a mobile phone, a broadcaster or a live broadcast controller.

7. The audio playback system according to claim 1, wherein the audio output device is in communication with the computing device in a wired transmission manner or a wireless transmission manner.

8. The audio playback system according to claim 3, wherein when the audio output device and the computing device are in communication with each other in a wired transmission manner, the computing device automatically execute the EQ setting program, or the computing device disables the EQ setting program.

9. The audio playback system according to claim 3, wherein when the audio output device is paired with the computing device in a Bluetooth communication manner, the computing device automatically execute the EQ setting program, or the computing device disables the EQ setting program.

10. The audio playback system according to claim 3, wherein when the audio output device is paired with the computing device through a dongle, the computing device automatically execute the EQ setting program, or the computing device disables the EQ setting program.
